(19) United States
(12) Patent Application Publication
(10) Pub. No.: US 2005/0006865 A1
(43) Pub. Date: Jan. 13, 2005

(54) Kids-powered entertainment car

(76) Inventor: Hongzhi Bao, Taizhou (CN)

Correspondence Address: Bin Chen, 48 Insmill Cres., Kanata, ON, K2T 1G4, CA

(21) Appl. No.: 10/616,593

(22) Filed: Jul. 11, 2003

(51) Int. Cl. B62M 1/00

(52) U.S. Cl. 280/87.01

(57) ABSTRACT

The invention discloses a new kid-power entertainment car consisting of a car body, a driving triangular base, a steering shaft, a steering wheel, and two rear wheels. The invention discloses a new design with greater safety for this type of toy cars. It comprises mounting auxiliary wheel(s) at the end of the front arm of the driving triangular base, adding a safe seating base at the top of the rear end the car body. Most importantly, the invention discloses a unique method to integrate the driving triangular base with the steering shaft. This invention also discloses a complete design with photos.

### FIELD OF THE INVENTION

The invention herein relating to a new kid-powered entertainment car proposes a safer unique design, mainly to provide auxiliary wheel(s) mounted on the front end of the convex driving triangular base, and a safe seating base on the top surface at the rear end of the body. Most importantly, the invention discloses a unique method to integrate the driving triangular base with the steering shaft. Accordingly, a complete design with photos is disclosed.

### BACKGROUND OF THE INVENTION

The existing kid-powered entertainment car consists of a car body, a driving triangular base, two driving wheels mounted at the left and right corners of the rear end of the driving triangular base respectively. A steering shaft, mounted through the car body, connects a steering bar at top to the driving triangular base at bottom. There are two idle rear wheels mounted at the left and right corners of the car body at the rear end. By turning the steering bar from the left to the right or from the right to the left, the car can be driven as it wiggles in the forward or backward direction. However, if the steering bar is manipulated to tilt accidentally at a large angle, the existing design can cause the car to flip over easily as the center of gravity of the car has moved out of the so-called equilibrium zone as defined by the four wheels of the car.

Another serious issue associated with the existing kid-powered car is that the driving triangular base is basically separated from the steering shaft. The two parts are attached together by a screw. The major problem of the design is that the screw can be loosened by the repetitive rotation of the steering bar. This is not only a problem in the design quality, but also a problem of safety for the user.

### SUMMARY OF THE INVENTION

The invention discloses a unique design that is going to solve the existing problems for the traditional kid-powered entertainment car. Specifically, the invention consists of adding an auxiliary wheel (single wheel or double wheels) mounted on the extended front arm of the driving triangular base, which increases the safety area and avoid the car flip-over; a safety seating base which is a soft plastic base fixed on the rear top surface of the car body and which indicates a rider should seat inside the seating area to avoid any possible flip-over; moreover, the invention also discloses an arrangement to manufacture the shaft and the driving triangular base into one piece to avoid the loose between them which would lead a serious safety concern.

### BRIEF DESCRIPTION OF THE DRAWINGS

FIG. 1 is a pictorial side elevation drawing of the invention herein.

FIG. 2 is a pictorial bottom side drawing of the invention herein.

FIG. 3 and FIG. 4 are pictorial drawings of the invention of the single unit illustrating the driving triangular base embedded with the shaft base.

FIG. 5 is the top-down view of the final design (photo).

FIG. 6 is the bottom-up view of the final design (photo).

FIG. 7 is the left-side view of the final design (photo).

FIG. 8 is the right-side view of the final design (photo).

FIG. 9 is the front view of the final design (photo).

FIG. 10 is the rear view of the final design (photo).

FIG. 11 is the top-down view of the steering butterfly wheel (photo).

FIG. 12 is the bottom-up view of the convex driving triangular base (photo).

### DETAILED DESCRIPTION OF EXEMPLARY EMBODIMENT(S)

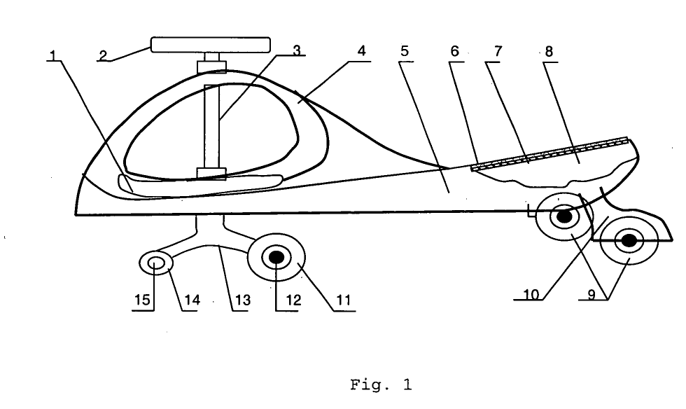

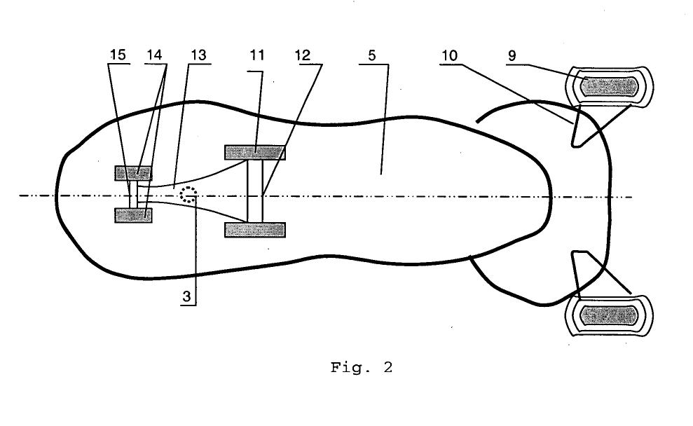

Referring to FIG. 1, the new invention of the kid-powered entertainment car comprises a piece of plastic 1 for the comfort of the feet, a steering wheel 2, a shaft 3 through the car body 5 and a frame 4 connecting the steering wheel at the top with the driving triangular base 13 at the bottom, a soft seating base to promote safety 6, a cover 7, a hollow space 8, a pair of rear wheels 9 installed on the rear wheel supports 10, a pair of driving wheels 11 mounted at the left and right corners of the rear end of the driving triangular base 13, an axle 12 for the driving wheels, and an auxiliary wheel 14 installed on an axle 14.

To prevent the flip-over, the invention utilizes two solutions: add an auxiliary wheel and the safety-seating base. The auxiliary wheel is used to increase the safety area and avoid the flip-over. The auxiliary wheel is a directional wheel. The directional wheel rotates in the same direction as the driving wheels. If the directional wheel is used, it can be a single wheel or a pair of wheels arranged symmetrically on the left side and right side at the end of the front arm of the driving triangular base. The directional wheel will generate a frictional force to slow down the speed of the car when the car is turning and the auxiliary wheel(s) are in operation. The auxiliary wheel(s) should be idle (not touching the ground) in normal operation. If the car leans to a flip-over condition then the wheel will touch the ground and thus prevents the flipping-over of the car.

The flip-over can also be prevented if a rider is guided to seat inside the safety-seating area 6. To increase the visibility of the safety-seating base, it is strongly recommended that the color of the safety-seating base should be different from that of the car body. In such a case, the center of gravity of the whole system is always located in the rear portion of the car close to the middle of the two rear wheels such that it will remain inside the equilibrium zone even if one of the driving wheels and two rear wheels establish the equilibrium zone. However, to ensure the maximum safety, the invention utilizes both solutions.

On the other hand, the invention also discloses an innovative method to prevent the loosening of the screw that attaches the shaft base to the driving triangular base. That is, they are mechanically molded together and therefore, they could not be separated at any instant.

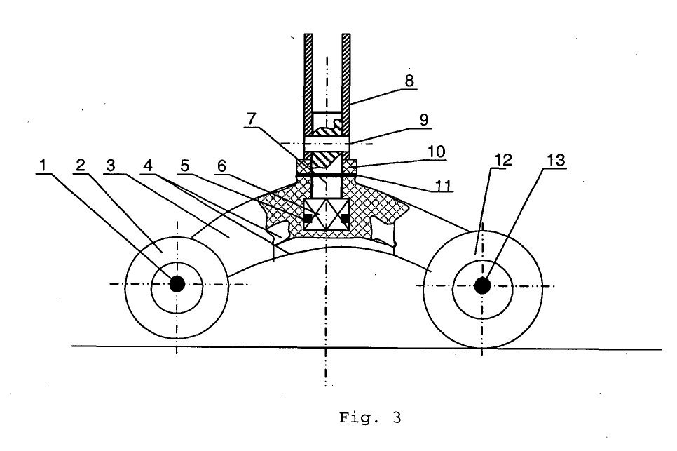

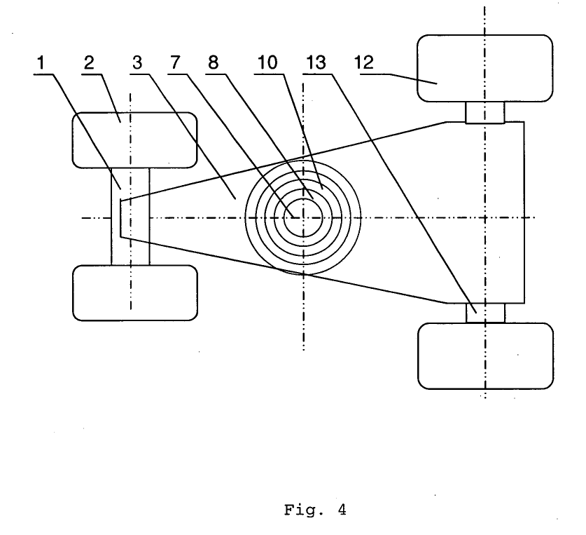

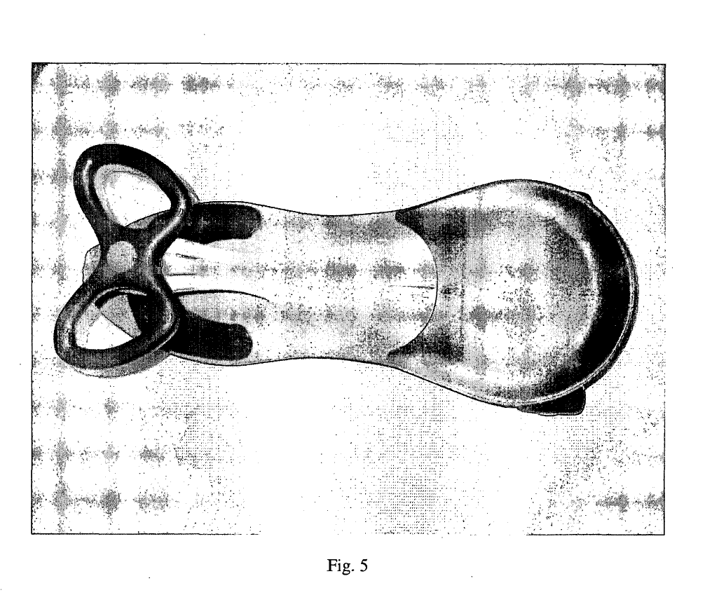

FIG. 3 illustrates the new invention for the unique integration of driving triangular base and the shaft base. The convex driving triangular base 3 is made of plastic materials. The convex shape is used to strengthen the driving base and enable the base to bear heavier loads. Two driving wheels 12, connected by an axle 13, are installed at the rear edge of the base. The auxiliary wheel pair are connected by an axle 1 and then mounted at the end of the front arm of the base. The auxiliary wheels should be smaller than driving wheels, which prevent them from touching the ground in normal operation. Some enhancing frames 4 are used to strengthen the base. In order to encase the shaft base into the driving triangular base (3), the bottom end of the cylinder axle (7) is designed to be a polygon shaped cylinder (6) with slots (5) on its sides. During the moulding process of the complete base, plastic materials will fill into the slots (5) and hence the cylinder will be tightly buried into the base after the plastic has solidified and cooled down. At the upper end of the axle (7), there is a hole as shown in FIG. 5. This hole is used to connect the axle (7) to the shaft base (8) by a pin (9). In the installation process, a washer (11) and a bearing (10) are used.

In another embodiment, the driving triangular base is made of metal. Therefore, the shaft base can be very easily moulded together with the driving triangular base.

1). A new kid-powered entertainment car which comprises: a car body, driving triangular base, two rear wheels mounted at the rear of the body, a shaft base, steering wheel (bar), soft safe seating base installed on the top portion of the body at the rear end of the car.

2). As claimed in claim (1), the car body is made of high quality plastic materials. There is a soft seating base installed for safety purposes on the top portion of the car body at the rear end of the car.

3). As claimed in claim (1), there is one plastic plate on each side of the top portion of the body.

4). As claimed in claim (1), the auxiliary wheel can be single directional wheel or two directional wheels mounted symmetrically at the end of the front arm of the driving triangular base.

5). As claimed in claim (1) and (4), the driving triangular base is convex in shape with enhancing frames.

6). As claimed in claims (5), the shaft base is fixed to an axle 7 by a pin 9. The axle 7 has a polygon shaped cylinder 6 at the bottom. There is a slot on each vertical side 5 of the polygon.

7). As claimed in claim (6), the polygon shaped cylinder 6 is embedded within the driving triangular base at the centre position. The side slots 5 will be filled in with plastic materials during the moulding process.

8). As claimed in claim (5) and (7), the driving triangular base can be optionally made of metal. In such a case, the axle 7 can be directly moulded with the convex base.

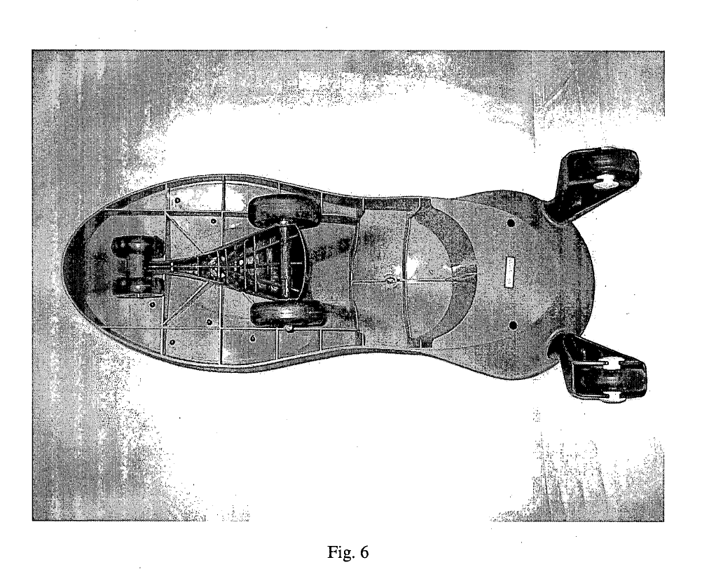

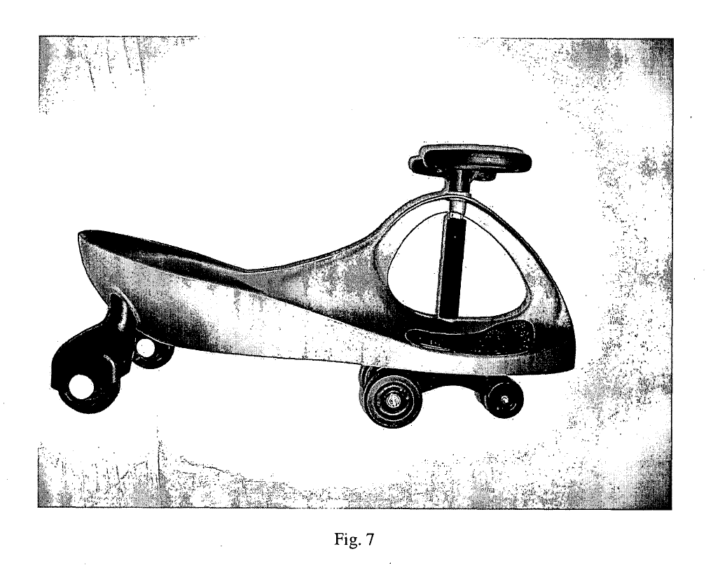

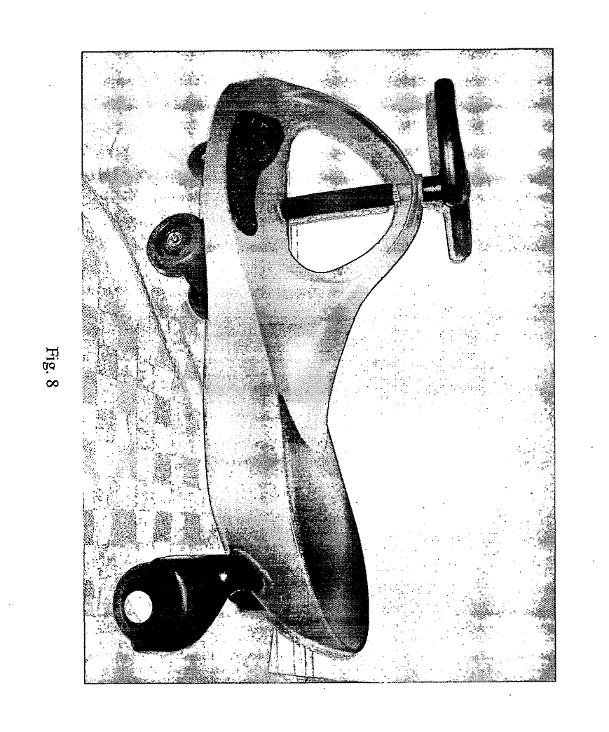

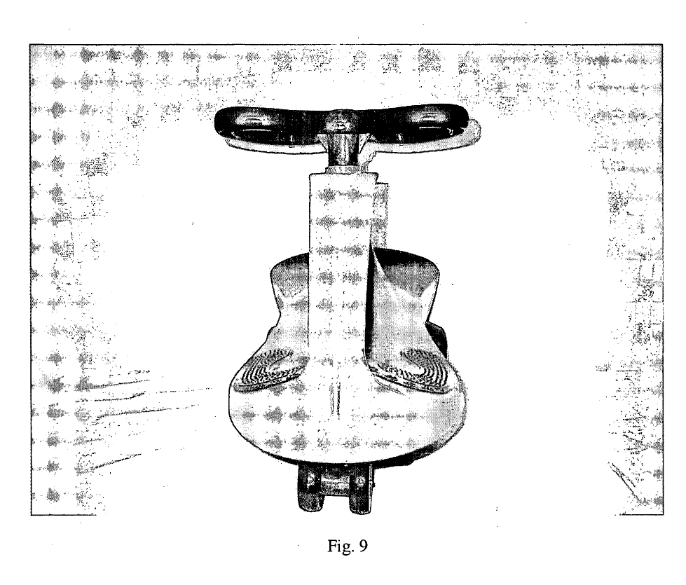

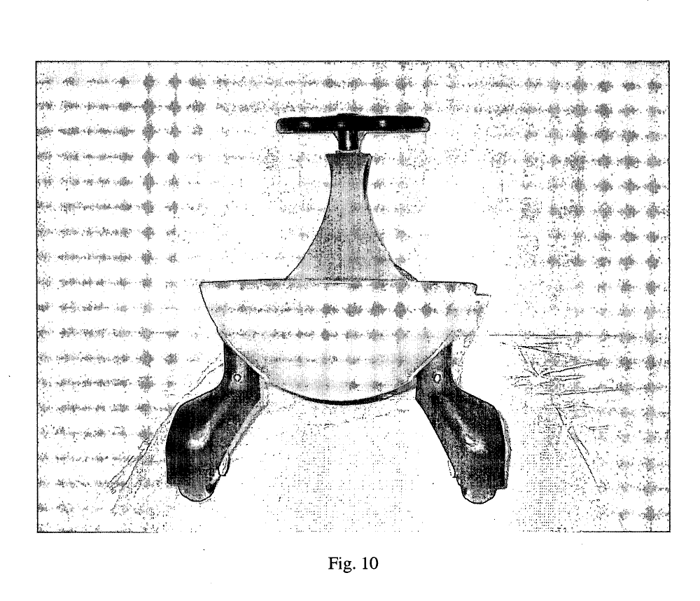

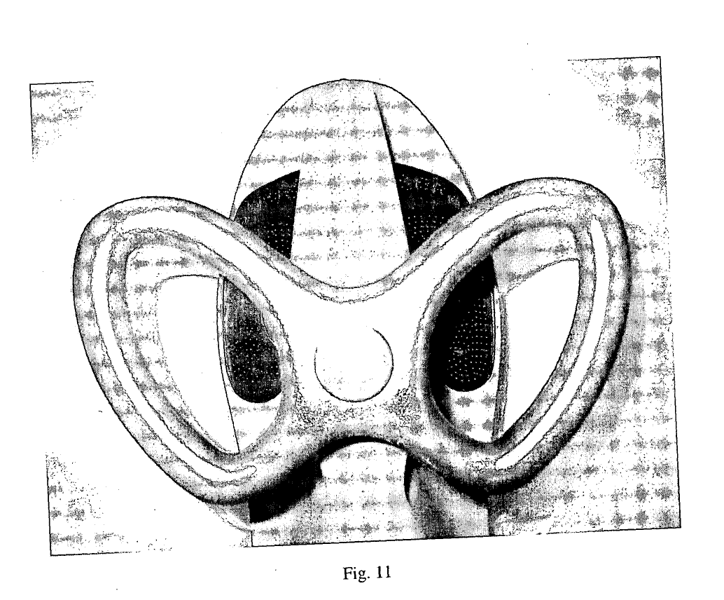

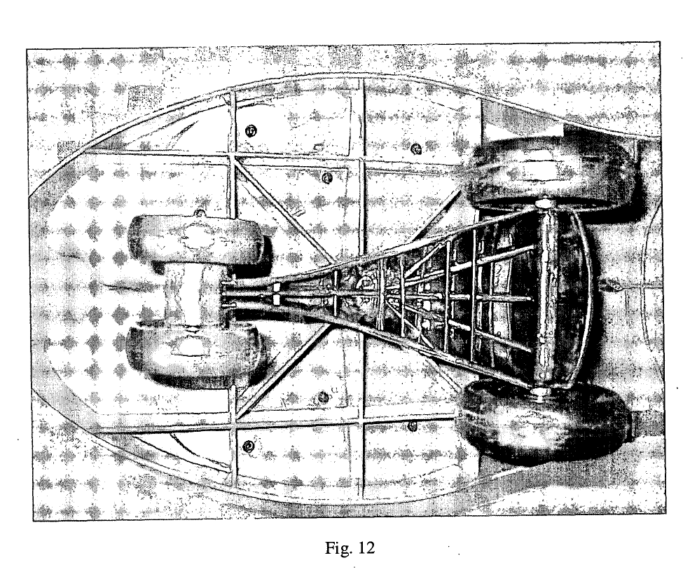

9). Based on the principles claimed as in the above claims 1 to 7, a complete design has been disclosed as shown in FIG. 5-FIG. 12. However, the principles disclosed in this article can be easily used to design different shapes.
